(19) United States
(12) Patent Application Publication
(10) Pub. No.: US 2002/0044152 A1
(43) Pub. Date: Apr. 18, 2002

(54) Dynamic integration of computer generated and real world images

(76) Inventors: Kenneth H. Abbott III, Kirkland, WA (US); Dan Newell, Medina, WA (US); James O. Robarts, Redmond, WA (US)

Correspondence Address: LEE & HAYES, PLLC, 421 W. RIVERSIDE AVE, STE 500, SPOKANE, WA, 99201, US

(21) Appl. No.: 09/879,827

(22) Filed: Jun. 11, 2001

Related U.S. Application Data
(60) Provisional application No. 60/240,672, filed on Oct. 16, 2000.
(60) Provisional application No. 60/240,684, filed on Oct. 16, 2000.

(51) Int. Cl. G09G 5/00

(52) U.S. Cl. 345/629

(57) ABSTRACT

A system integrates virtual information with real world images presented on a display, such as a head-mounted display of a wearable computer. The system modifies how the virtual information is presented to alter whether the virtual information is more or less visible relative to the real world images. The modification may be made dynamically, such as in response to a change in the user's context, or user's eye focus on the display, or a user command. The virtual information may be modified in a number of ways, such as adjusting the transparency of the information, modifying the color of the virtual information, enclosing the information in borders, and changing the location of the virtual information on the display. Through these techniques, the system provides the information to the user in a way that minimizes distraction of the user's view of the real world images.

### RELATED APPLICATIONS

A claim of priority is made to U.S. Provisional Application No. 60/240,672, filed Oct. 16, 2000, entitled “Method For Dynamic Integration Of Computer Generated And Real World Images”, and to U.S. Provisional Application No. 60/240,684, filed Oct. 16, 2000, entitled “Methods for Visually Revealing Computer Controls”.

### TECHNICAL FIELD

The present invention is directed to controlling the appearance of information presented on displays, such as those used in conjunction with wearable personal computers. More particularly, the invention relates to transparent graphical user interfaces that present information transparently on real world images to minimize obstructing the user's view of the real world images.

### BACKGROUND

As computers become increasingly powerful and ubiquitous, users increasingly employ their computers for a broad variety of tasks. For example, in addition to traditional activities such as running word processing and database applications, users increasingly rely on their computers as an integral part of their daily lives. Programs to schedule activities, generate reminders, and provide rapid communication capabilities are becoming increasingly popular. Moreover, computers are increasingly present during virtually all of a person's daily activities. For example, hand-held computer organizers (e.g., PDAs) are more common, and communication devices such as portable phones are increasingly incorporating computer capabilities. Thus, users may be presented with output information from one or more computers at any time.

While advances in hardware make computers increasingly ubiquitous, traditional computer programs are not typically designed to efficiently present information to users in a wide variety of environments. For example, most computer programs are designed with a prototypical user being seated at a stationary computer with a large display device, and with the user devoting full attention to the display. In that environment, the computer can safely present information to the user at any time, with minimal risk that the user will fail to perceive the information or that the information will disturb the user in a dangerous manner (e.g., by startling the user while they are using power machinery or by blocking their vision while they are moving with information sent to a head-mounted display). However, in many other environments these assumptions about the prototypical user are not true, and users thus may not perceive output information (e.g., failing to notice an icon or message on a hand-held display device when it is holstered, or failing to hear audio information when in a noisy environment or when intensely concentrating). Similarly, some user activities may have a low degree of interruptibility (i.e., ability to safely interrupt the user) such that the user would prefer that the presentation of low-importance or of all information be deferred, or that information be presented in a non-intrusive manner.

Consider an environment in which the user must be cognizant of the real world surroundings simultaneously with receiving information. Conventional computer systems have attempted to display information to users while also allowing the user to view the real world. However, such systems are unable to display this virtual information without obscuring the real-world view of the user. Virtual information can be displayed to the user, but doing so visually impedes much of the user's view of the real world.

Often the user cannot view the computer-generated information at the same time as the real-world information. Rather, the user is typically forced to switch between the real world and the virtual world by either mentally changing focus or by physically actuating some switching mechanism that alters between displaying the real world and displaying the virtual word. To view the real world, the user must stop looking at the display of virtual information and concentrate on the real world. Conversely, to view the virtual information, the user must stop looking at the real world.

Switching display modes in this way can lead to awkward, or even dangerous, situations that leave the user in transition and sometimes in the wrong mode when they need to deal with an important event. An example of this awkward behavior is found in inadequate current technology of computer displays that are worn by users. Some computer hardware is equipped with an extra piece of hardware that flips down behind the visor display. This effect creates complete background opaqueness when the user needs to view more information, or needs to view it without the distraction of the real-world image.

Accordingly, there is a need for new techniques to display virtual information to a user in a manner that does not disrupt, or disrupts very little, the user's view of the real world.

### SUMMARY

A system is provided to integrate computer-generated virtual information with real world images on a display, such as a head-mounted display of a wearable computer. The system presents the virtual information in a way that creates little interference with the user's view of the real world images. The system further modifies how the virtual information is presented to alter whether the virtual information is more or less visible relative to the real world images. The modification may be made dynamically, such as in response to a change in the user's context, or user's eye focus on the display, or a user command.

The virtual information may be modified in a number of ways. In one implementation, the virtual information is presented transparently on the display and overlays the real world images. The user can easily view the real world images through the transparent information. The system can then dynamically adjust the degree of transparency across a range from fully transparent to fully opaque depending upon how noticeable the information is to be displayed.

In another implementation, the system modifies the color of the virtual information to selectively blend or contrast the virtual information with the real world images. Borders may also be drawn around the virtual information to set it apart. Another way to modify presentation is to dynamically move the virtual information on the display to make it more or less prominent for viewing by the user.

### BRIEF DESCRIPTION OF THE DRAWINGS

FIG. 1 illustrates a wearable computer having a head mounted display and mechanisms for displaying virtual information on the display together with real world images.

FIG. 2 is a diagrammatic illustration of a view of real world images through the head mounted display. The illustration shows a transparent user interface (UI) that presents computer-generated information on the display over the real world images in a manner that minimally distracts the user's vision of the real world images.

FIG. 3 is similar to FIG. 2, but further illustrates a transparent watermark overlaid on the real world images.

FIG. 4 is similar to FIG. 2, but further illustrates context specific information depicted relative to the real world images.

FIG. 5 is similar to FIG. 2, but further illustrates a border about the information.

FIG. 6 is similar to FIG. 2, but further illustrates a way to modify prominence of the virtual information by changing its location on the display.

FIG. 7 is similar to FIG. 2, but further illustrates enclosing the information within a marquee.

FIG. 8 shows a process for integrating computer-generated information with real world images on a display.

### DETAILED DESCRIPTION

Described below is a system and user interface that enables simultaneous display of virtual information and real world information with minimal distraction to the user. The user interface is described in the context of a head mounted visual display (e.g., eye glasses display) of a wearable computing system that allows a user to view the real world while overlaying additional virtual information. However, the user interface may be used for other displays and in contexts other than the wearable computing environment.

Exemplary System

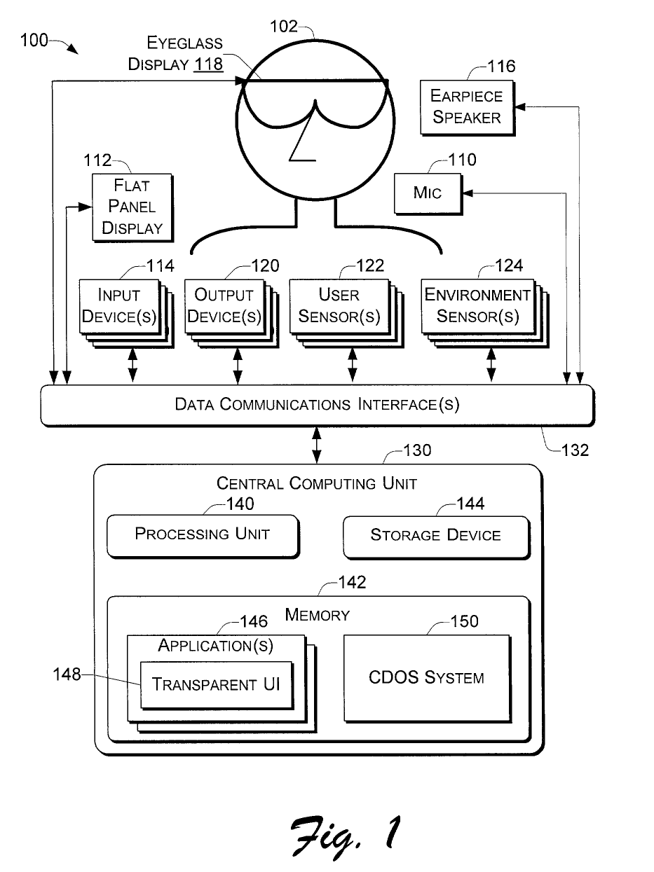

FIG. 1 illustrates a body-mounted wearable computer 100 worn by a user 102. The computer 100 includes a variety of body-worn input devices, such as a microphone 110, a hand-held flat panel display 112 with character recognition capabilities, and various other user input devices 114. Examples of other types of input devices with which a user can supply information to the computer 100 include voice recognition devices, traditional qwerty keyboards, chording keyboards, half qwerty keyboards, dual forearm keyboards, chest mounted keyboards, handwriting recognition and digital ink devices, a mouse, a track pad, a digital stylus, a finger or glove device to capture user movement, pupil tracking devices, a gyropoint, a trackball, a voice grid device, digital cameras (still and motion), and so forth.

The computer 100 also has a variety of body-worn output devices, including the hand-held flat panel display 112, an earpiece speaker 116, and a head-mounted display in the form of an eyeglass-mounted display 118. The eyeglass-mounted display 118 is implemented as a display type that allows the user to view real world images from their surroundings while simultaneously overlaying or otherwise presenting computer-generated information to the user in an unobtrusive manner. The display may be constructed to permit direct viewing of real images (i.e., permitting the user to gaze directly through the display at the real world objects) or to show real world images captured from the surroundings by video devices, such as digital cameras. The display and techniques for integrating computer-generated information with the real world surrounding are described below in greater detail. Other output devices 120 may also be incorporated into the computer 100, such as a tactile display, an olfactory output device, tactile output devices, and the like.

The computer 100 may also be equipped with one or more various body-worn user sensor devices 122. For example, a variety of sensors can provide information about the current physiological state of the user and current user activities. Examples of such sensors include thermometers, sphygmometers, heart rate sensors, shiver response sensors, skin galvanometry sensors, eyelid blink sensors, pupil dilation detection sensors, EEG and EKG sensors, sensors to detect brow furrowing, blood sugar monitors, etc. In addition, sensors elsewhere in the near environment can provide information about the user, such as motion detector sensors (e.g., whether the user is present and is moving), badge readers, still and video cameras (including low light, infra-red, and x-ray), remote microphones, etc. These sensors can be both passive (i.e., detecting information generated external to the sensor, such as a heart beat) or active (i.e., generating a signal to obtain information, such as sonar or x-rays).

The computer 100 may also be equipped with various environment sensor devices 124 that sense conditions of the environment surrounding the user. For example, devices such as microphones or motion sensors may be able to detect whether there are other people near the user and whether the user is interacting with those people. Sensors can also detect environmental conditions that may affect the user, such as air thermometers or geigercounters. Sensors, either body-mounted or remote, can also provide information related to a wide variety of user and environment factors including location, orientation, speed, direction, distance, and proximity to other locations (e.g., GPS and differential GPS devices, orientation tracking devices, gyroscopes, altimeters, accelerometers, anemometers, pedometers, compasses, laser or optical range finders, depth gauges, sonar, etc.). Identity and informational sensors (e.g., bar code readers, biometric scanners, laser scanners, OCR, badge readers, etc.) and remote sensors (e.g., home or car alarm systems, remote camera, national weather service web page, a baby monitor, traffic sensors, etc.) can also provide relevant environment information.

The computer 100 further includes a central computing unit 130 that may or may not be worn on the user. The various inputs, outputs, and sensors are connected to the central computing unit 130 via one or more data communications interfaces 132 that may be implemented using wire-based technologies (e.g., wires, coax, fiber optic, etc.) or wireless technologies (e.g., RF, etc.).

The central computing unit 130 includes a central processing unit (CPU) 140, a memory 142, and a storage device 144. The memory 142 may be implemented using both volatile and non-volatile memory, such as RAM, ROM, Flash, EEPROM, disk, and so forth. The storage device 144 is typically implemented using non-volatile permanent memory, such as ROM, EEPROM, diskette, memory cards, and the like.

One or more application programs 146 are stored in memory 142 and executed by the CPU 140. The application programs 146 generate data that may be output to the user via one or more of the output devices 112, 116, 118, and 120. For discussion purposes, one particular application program is illustrated with a transparent user interface (UI) component 148 that is designed to present computer-generated information to the user via the eyeglass mounted display 118 in a manner that does not distract the user from viewing real world parameters. The transparent UI 148 organizes orientation and presentation of the data and provides the control parameters that direct the display 118 to place the data before the user in many different ways that account for such factors as the importance of the information, relevancy to what is being viewed in the real world, and so on.

In the illustrated implementation, a Condition-Dependent Output Supplier (CDOS) system 150 is also shown stored in memory 142. The CDOS system 148 monitors the user and the user's environment, and creates and maintains an updated model of the current condition of the user. As the user moves about in various environments, the CDOS system receives various input information including explicit user input, sensed user information, and sensed environment information. The CDOS system updates the current model of the user condition, and presents output information to the user via appropriate output devices.

Of particular relevance, the CDOS system 150 provides information that might affect how the transparent UI 148 presents the information to the user. For instance, suppose the application program 146 is generating geographical or spatial relevant information that should only be displayed when the user is looking in a specific direction. The CDOS system 150 may be used to generate data indicating where the user is looking. If the user is looking in the correct direction, the transparent UI 148 presents the data in conjunction with the real world view of that direction. If the user turns his/her head, the CDOS system 148 detects the movement and informs the application program 146, enabling the transparent UI 148 to remove the information from the display.

A more detailed explanation of the CDOS system 130 may be found in a co-pending U.S. patent application Ser. No. 09/216,193, entitled “Method and System For Controlling Presentation of Information To a User Based On The User's Condition”, which was filed Dec. 18, 1998, and is commonly assigned to Tangis Corporation. The reader might also be interested in reading U.S. paten application Ser. No. 09/724,902, entitled “Dynamically Exchanging Computer User's Context”, which was filed Nov. 28, 2000, and is commonly assigned to Tangis Corporation. These applications are hereby incorporated by reference.

Although not illustrated, the body-mounted computer 100 may be connected to one or more networks of other devices through wired or wireless communication means (e.g., wireless RF, a cellular phone or modem, infrared, physical cable, a docking station, etc.). For example, the body-mounted computer of a user could make use of output devices in a smart room, such as a television and stereo when the user is at home, if the body-mounted computer can transmit information to those devices via a wireless medium or if a cabled or docking mechanism is available to transmit the information. Alternately, kiosks or other information devices can be installed at various locations (e.g., in airports or at tourist spots) to transmit relevant information to body-mounted computers within the range of the information device.

Transparent UI

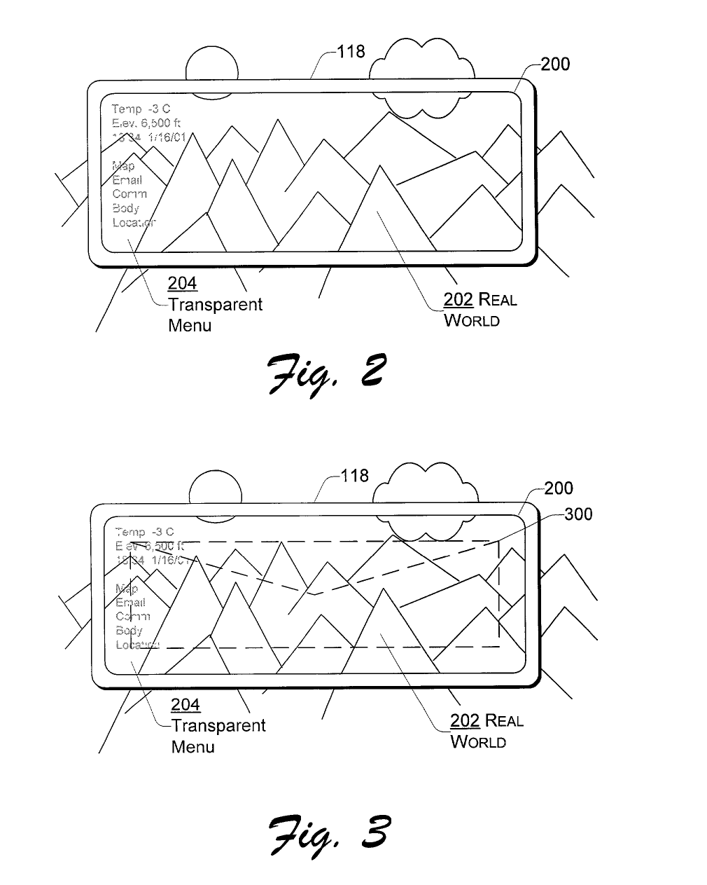

FIG. 2 shows an exemplary view that the user of the wearable computer 100 might see when looking at the eyeglass mounted display 118. The display 118 depicts a graphical screen presentation 200 generated by the transparent UI 148 of the application program 146 executing on the wearable computer 100. The screen presentation 200 permits viewing of the real world surrounding 202, which is illustrated here as a mountain range.

The transparent screen presentation 200 presents information to the user in a manner that does not significantly impede the user's view of the real world 202. In this example, the virtual information consists of a menu 204 that lists various items of interest to the user. For the mountain-scaling environment, the menu 204 includes context relevant information such as the present temperature, current elevation, and time. The menu 204 may further include navigation items that allow the user to navigate to various levels of information being monitored or stored by the computer 100. Here, the menu items include mapping, email, communication, body parameters, and geographical location. The menu 204 is placed along the side of the display to minimize any distraction from the user's vision of the real world.

The menu 204 is presented transparently, enabling the user to see the real world images 202 behind the menu. By making the menu transparent and locating it along the side of the display, the information is available for the user to see, but does not impair the user's view of the mountain range.

The transparent UI possesses many features that are directed toward the goal of displaying virtual information to the user without impeding too much of the user's view of the real world. Some of these features are explored below to provide a better understanding of the transparent UI.

Dynamically Changing Degree of Transparency

The transparent UI 148 is capable of dynamically changing the transparency of the virtual information. The application program 146 can change the degree of transparency of the menu 204 (or other virtual objects) by implementing a display range from completely opaque to completely transparent. This display range allows the user to view both real world and virtual-world information at the same time, with dynamic changes being performed for a variety of reasons.

One reason to change the transparency might be the level of importance ascribed to the information. As the information is deemed more important by the application program 146 or user, the transparency is decreased to draw more attention to the information.

Another reason to vary transparency might be context specific. Integrating the transparent UI into a system that models the user's context allows the transparent UI to vary the degree of transparency in response to a rich set of states from the user, their environment, or the computer and its peripheral devices. Using this model, the system can automatically determine what parts of the virtual information to display as more or less transparent and vary their respective transparencies accordingly.

For example, if the information becomes more important in a given context, the application program may decrease the transparency toward the opaque end of the display range to increase the noticeability of the information for the user. Conversely, if the information is less relevant for a given context, the application program may increase the transparency toward the fully transparent end of the display range to diminish the noticeability of the virtual information.

Another reason to change transparency levels may be due to a change in the user's attention on the real world. For instance, a mapping program may display directional graphics when the user is looking in one direction and fade those graphics out (i.e., make them more transparent) when the user moves his/her head to look in another direction.

Another reason might be the user's focus as detected, for example, by the user's eye movement or focal point. When the user is focused on the real world, the virtual object's transparency increases as the user no longer focuses on the object. On the other hand, when the user returns their focus to the virtual information, the objects become visibly opaque.

The transparency may further be configured to change over time, allowing the virtual image to fade in and out depending on the circumstances. For example, an unused window can fade from view, becoming very transparent or perhaps eventually fully transparent, when the user maintains their focus elsewhere. The window may then fade back into view when the user attention is returned to it.

Increased transparency generally results in the user being able to see more of the real-world view. In such a configuration, comparatively important virtual objects—like those used for control, status, power, safety, etc.—are the last virtual objects to fade from view. In some configurations, the user may configure the system to never fade specified virtual objects. This type of configuration can be performed dynamically on specific objects or by making changes to a general system configuration.

The transparent UI can also be controlled by the user instead of the application program. Examples of this involve a visual target in the user interface that is used to adjust transparency of the virtual objects being presented to the user. For example, this target can be a control button or slider that is controlled by any variety of input methods available to the user (e.g., voice, eye-tracking controls to control the target/control object, keyboard, etc.).

Watermark Notification

The transparent UI 148 may also be configured to present faintly visible notifications with high transparency to hint to the user that additional information is available for presentation. The notification is usually depicted in response to some event about which an application desires to notify the user. The faintly visible notification notifies the user without disrupting the user's concentration on the real world surroundings. The virtual image can be formed by manipulating the real world image, akin to watermarking the digital image in some manner.

FIG. 3 shows an example of a watermark notification 300 overlaid on the real world image 202. In this example, the watermark notification 300 is a graphical envelope icon that suggests to the user that new, unread electronic mail has been received. The envelope icon is illustrated in dashed lines around the edge of the full display to demonstrate that the icon is faintly visible (or highly transparent) to avoid obscuring the view of the mountain range. Thus, the user is able to see through the watermark due to its partial transparency, thus helping the user to easily focus on the current task.

The notification may come in many different shapes, positions, and sizes, including a new window, other icon shapes, or some other graphical presentation of information to the user. Like the envelope, the watermark notification can be suggestive of a particular task to orient the user to the task at hand (i.e., read mail).

Depending on a given situation, the application program 146 can decrease the transparency of the information and make it more or less visible. Such information can be used in a variety of situations, such as incoming information, or when more information related to the user's context or user's view (both virtual and real world) is available, or when a reminder is triggered, or anytime more information is available than can be viewed at one time, or for providing “help”. Such watermarks can also be used for hinting to the user about advertisements that could be presented to the user.

The watermark notification also functions as an active control that may be selected by the user to control an underlying application. When the user looks at the watermark image, or in some other way selects the image, it becomes visibly opaque. The user's method for selecting the image includes any of the various ways a user of a wearable personal computer can perform selections of graphical objects (e.g., blinking, voice selection, etc.). The user can configure this behavior in the system before the commands are given to the system, or generate the system behaviors by commands, controls, or corrections to the system.

Once the user selects the image, the application program provides a suitable response. In the FIG. 3 example, user selection of the envelope icon 300 might cause the email program to display the newly received email message.

Context Aware Presentation

The transparent UI may also be configured to present information in different degrees of transparency depending upon the user's context. When the wearable computer 100 is equipped with context aware components (e.g., eye movement sensors, blink detection sensors, head movement sensors, GPS systems, and the like), the application program 146 may be provided with context data that influences how the virtual information is presented to the user via the transparent UI.

FIG. 4 shows one example of presenting virtual information according to the user's context. In particular, this example illustrates a situation where the virtual information is presented to the user only when the user is facing a particular direction. Here, the user is looking toward the mountain range. Virtual information 400 in the form of a climbing aid is overlaid on the display. The climbing aid 400 highlights a desired trail to be taken by the user when scaling the mountain.

The trail 400 is visible (i.e., a low degree of transparency) when the user faces in a direction such that the particular mountain is within the viewing area. As the user rotates their head slightly, while keeping the mountain within the viewing area, the trail remains indexed to the appropriate mountain, effectively moving across the screen at the rate of the head rotation.

If the user turns their head away from the mountain, the computer 100 will sense that the user is looking in another direction. This data will be input to the application program controlling the trail display and the trail 400 will be removed from the display (or made completely transparent). In this manner, the climbing aid is more intuitive to the user, appearing only when the user is facing the relevant task.

This is just one example of modifying the display of virtual information in conjunction with real world surroundings based on the user's context. There are many other situations that may dictate when virtual information is presented or withdrawn depending upon the user's context.

Bordering

Another technique for displaying virtual information to the user without impeding too much of the user's view of the real world is to border the computer-generated information. Borders, or other forms of outlines, are drawn around objects to provide greater control of transparency and opaqueness.

FIG. 5 illustrates the transparent UI 200 where a border 500 is drawn around the menu 204. The border 500 draws a bit more attention to the menu 204 without noticeably distracting from the user's view of the real world 202. Graphical images can be created with special borders embedded in the artwork, such that the borders can be used to highlight the virtual object.

Certain elements of the graphical information, like borders and titles, can also be given different opaque curves relating to visibility. For example, the border 500 might be assigned a different degree of transparency compared to the menu items 204 so that the border 500 would be the last to become fully transparent as the menu's transparency is increased. This behavior leaves the more distinct border 500 visible for the user to identify even after the menu items have been faded to nearly full transparency, thus leaving the impression that the virtual object still exists. This feature also provides a distinct border, which, as long as it is visible, helps the user locate a virtual image, regardless of the transparency of the rest of the image. Moreover, another feature is to group more than one related object (e.g., by drawing boxes about them) to give similar degrees of transparency to a set of objects simultaneously.

Marquees are one embodiment of object borders. Marquees are dynamic objects that add prominence beyond static or highlighted borders by flashing, moving (e.g.: cycling), or blinking the border around an object. These are only examples of the variety of ways a system can highlight virtual information so the user can more easily notice when the information is overlaid on top of the real-world view.

The application program may be configured to automatically detect edges of the display object. The edge information may then be used by the application program to generate object borders dynamically.

Color Changing

Another technique for displaying virtual information in a manner that educes the user's distraction from viewing of the real world is to change colors of the virtual objects to control their transparency, and hence visibility, against a changing real world view. When a user interface containing virtually displayed information such as program windows, icons, etc. is drawn with colors that clash with, or blend into, the background of real-world colors, the user is unable to properly view the information. To avoid this situation, the application program 146 can be configured to detect conflict of colors and re-map the virtual-world colors so the virtual objects can be easily seen by the user, and so that the virtual colors do not clash with the real-world colors. This color detection and re-mapping makes the virtual objects easier to see and promotes greater control over the transparency of the objects.

Where display systems are limited in size and capabilities (e.g., resolution, contrast, etc.), color re-mapping might further involve mapping a current virtual-world color-set to a smaller set of colors. The need for such reduction can be detected automatically by the computer or the user can control all configuration adjustments by directing the computer to perform this action.

Background Transparency

Another technique for presenting virtual information concurrently with the real world images is to manipulate the transparency of the background of the virtual information. In one implementation, the visual backgrounds of virtual information can be dynamically displayed, such that the application program 146 causes the background to become transparent. This allows the user of the system to view more of the real world. By supporting control of the transparent nature of the background of presented information, the application affords greater flexibility to the user for controlling the presentation of transparent information and further aids application developers in providing flexible transparent user interfaces.

Prominence

Another feature provided by the computer system with respect to the transparent UI is the concept of “prominence”. Prominence is a factor pertaining to what part of the display should be given more emphasis, such as whether the real world view or the virtual information should be highlighted to capture more of the user's attention. Prominence can be considered when determining many of the features discussed above, such as the degree of transparency, the position of the virtual information, whether to post a watermark notification, and the like.

In one implementation, the user dictates prominence. For example, the computer system uses data from tracking the user's eye movement or head movement to determine whether the user wants to concentrate on the real-world view or the virtual information. Depending on the user's focus, the application program will grant more or less prominence to the real world (or virtual information). This analysis allows the system to adjust transparency dynamically. If the user's eye is focusing on virtual objects, then those objects can be given more prominence, or maintain their current prominence without fading due to lack of use. If the user's eye is focusing on the real-world view, the system can cause the virtual world to become more opaque, and occlude less of the real world.

The variance of prominence can also be aided by understanding the user's context. By knowing the user's ability and safety, for example, the system can decide whether to permit greater prominence on the virtual world over the real world. Consider a situation where the user is riding a bus. The user desires the prominence to remain on the virtual world, but would still like the ability to focus temporarily on the real-world view. Brief flicks at the real-world view might be appropriate in this situation. Once the user reaches the destination and leaves the bus, the prominence of the virtual world is diminished in favor of the real world view.

This behavior can be configured by the user, or alternatively, the system can track eye focus to dynamically and automatically adjust the visibility of virtual information without occluding too much of the real world. The system may also be configured to respond to eye commands entered via prescribed blinking sequences. For instance, the user's eyes can control prominence of virtual objects via a left-eye blink, or right-eye blink. Then, an opposite eye-blink would give prominence to the real-world view, instead of the virtual-world view. Alternatively, the user can direct the system to give prominence to a specific view by issuing a voice command. The user can tell the system to increase or decrease transparency of the virtual world or virtual objects.

The system may further be configured to alter prominence dynamically in response to changes in the user's focus. Through eye tracking techniques, for example, the system can detect whether the user is looking at a specific virtual object. When the user has not viewed the object within a configurable length of time, the system slowly moves the object away from the center of the user's view, toward the user's peripheral vision.

FIG. 6 shows an example of a virtual object in the form of a compass 600 that is initially given prominence at a center position 602 of the display. Here, the user is focusing on the compass to get a bearing before scaling the mountain. When the user returns their attention to the climbing task and focuses once again on the real world 202, the eye tracking feedback is given to the application program, which slowly migrates the compass 600 from its center position to a peripheral location 604 as illustrated by the direction arrow 606. If the user does not stop the object from moving, it will reach the peripheral vision and thus be less of a distraction to the user.

The user can stipulate that the virtual object should return and/or remain in place by any one of a variety of methods. Some examples of such stop-methods are: a vocal command, a single long blink of an eye, focusing the eye on a controlling aspect of the object (like a small icon, similar in look to a close-window box on a PC window). Further configurable options from this stopped-state include the system's ability to eventually continue moving the object to the periphery, or instead, the user can lock the object in place (by another command similar to the one that stopped the original movement). At that point, the system no longer attempts to remove the object from the user's main focal area.

Marquees are dynamic objects that add prominence beyond static or highlighted borders by flashing, moving (e.g.: cycling) or blinking the border around an object. These are only examples of the variety of ways a system can increase prominence of virtual-world information so the user can more easily notice when the information is overlaid on top of the real-world view.

FIG. 7 shows an example of a marquee 700 that scrolls across the display to provide information to the user. In this example, the marquee 700 informs the user that their heart rate is reaching an 80% level.

Color mapping is another technique to adjust prominence, making virtual information standout or fade into the real-world view.

Method

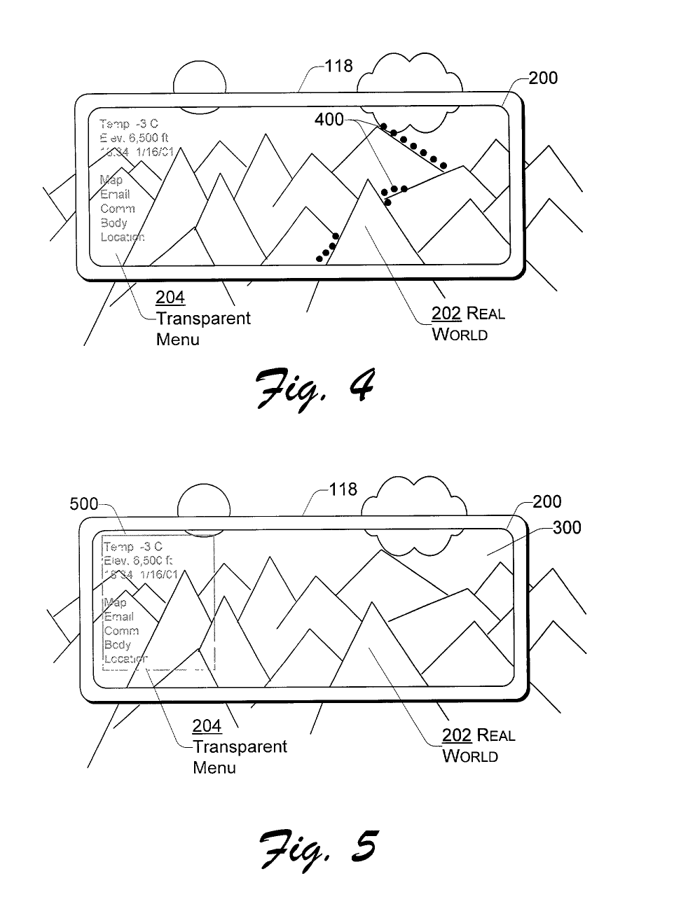

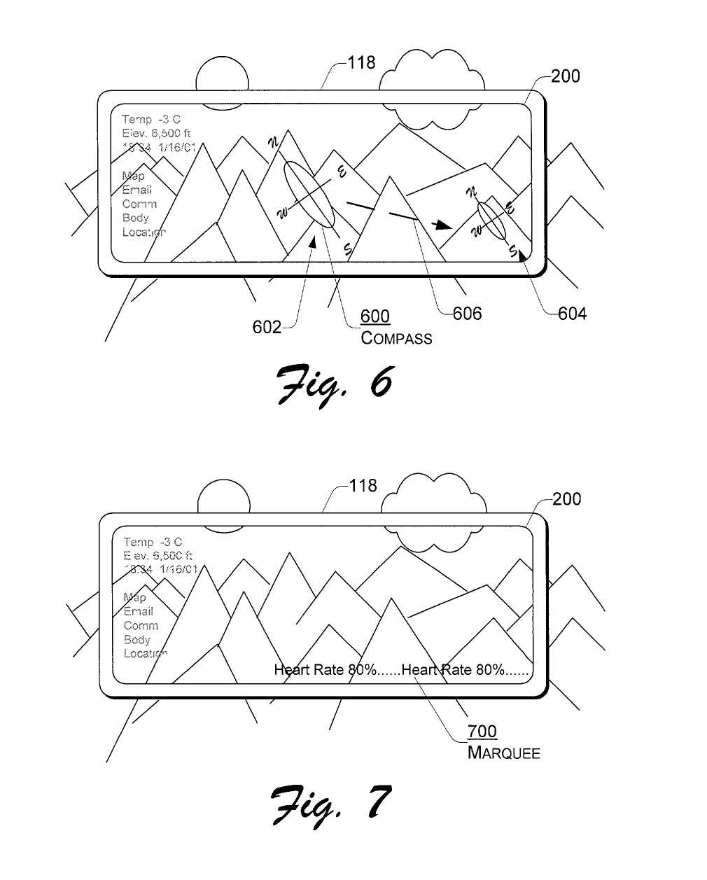

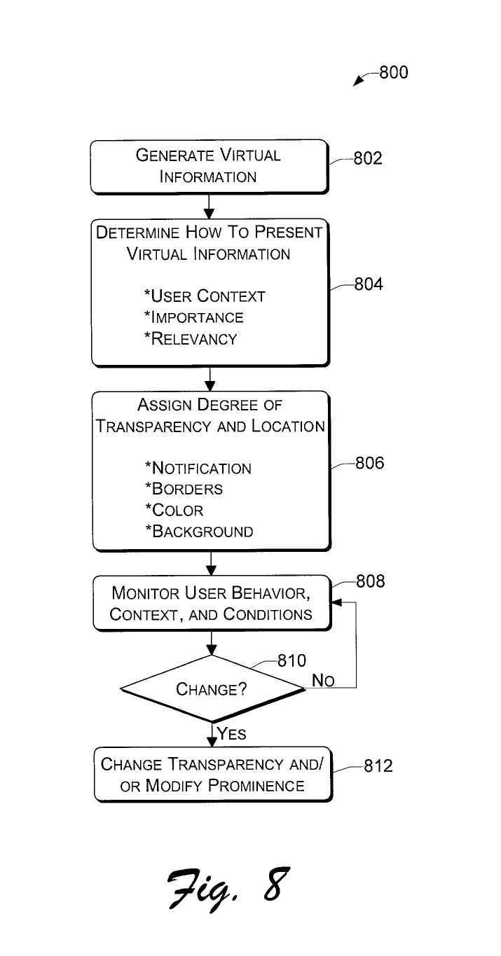

FIG. 8 shows processes 800 for operating a transparent UI that integrates virtual information within a real world view in a manner that minimizes distraction to the user. The processes 800 may be implemented in software, or a combination of hardware and software. As such, the operations illustrated as blocks in FIG. 8 may represent computer-executable instructions that, when executed, direct the system to display virtual information and the real world in a certain manner.

At block 802, the application program 146 generates virtual information intended to be displayed on the eyeglass-mounted display. The application program 146, and namely the transparent UI 148, determines how to best present the virtual information (block 804). Factors for such a determination include the importance of the information, the user's context, immediacy of the information, relevancy of the information to the context, and so on. Based on this information, the transparent UI 148 might initially assign a degree of transparency and a location on the display (block 806). In the case of a notification, the transparent UI 148 might present a faint watermark of a logo or other icon on the screen. The transparent UI 148 might further consider adding a border, or modifying the color of the virtual information, or changing the transparency of the information's background.

The system then monitors the user behavior and conditions that gave rise to presentation of the virtual information (block 808). Based on this monitoring or in response to express user commands, the system determines whether a change in transparency or prominence is justified (block 810). If so, the transparent UI modifies the transparency of the virtual information and/or changes its prominence by fading the virtual image out or moving it to a less prominent place on the screen (block 812).

Conclusion

Although the invention has been described in language specific to structural features and/or methodological acts, it is to be understood that the invention defined in the appended claims is not necessarily limited to the specific features or steps described. Rather, the specific features and steps are disclosed as exemplary forms of implementing the claimed invention.

1. A method comprising:
presenting computer-generated information on a display that permits viewing of a real world context; and
assigning a degree of transparency to the information to enable display of the information to a user without impeding the user's view of the real world context.

2. A method as recited in claim 1, further comprising dynamically adjusting the degree of transparency of the information.

3. A method as recited in claim 1, further comprising:
receiving data pertaining to the user's context; and
dynamically adjusting the degree of transparency upon changes in the user's context.

4. A method as recited in claim 1, further comprising:
receiving data pertaining to the user's eye focus on the display; and
dynamically adjusting the degree of transparency due to change in the user's eye focus.

5. A method as recited in claim 1, further comprising:
selecting an initial location on the display to present the information; and
subsequently moving the information from the initial location to a second location.

6. A method as recited in claim 1, farther comprising presenting a border around the information.

7. A method as recited in claim 1, further comprising presenting the information within a marquee.

8. A method as recited in claim 1, further comprising presenting the information as a faintly visible graphic overlaid on the real world context.

9. A method as recited in claim 1, further comprising modifying a color of the information to alternately blend or distinguish the information from the real world context.

10. A method as recited in claim 1, wherein the information is presented against a background, and further comprising adjusting transparency of the background.

11. A method comprising:
presenting information on a screen that permits viewing real images, the information being presented in a first degree of transparency; and
modifying presentation of the information to a second degree of transparency.

12. A method as recited in claim 11, wherein the first degree of transparency is more transparent than the second degree of transparency.

13. A method as recited in claim 11, wherein the transparency ranges from fully transparent to fully opaque.

14. A method as recited in claim 11, wherein said modifying is performed in response to change of importance attributed to the information.

15. A method as recited in claim 11, wherein said modifying is performed in response to a user command.

16. A method as recited in claim 11, wherein said modifying is performed in response to a change in user context.

17. A method for operating a display that permits a view of real images, comprising:
generating a notification event; and
presenting, on the display, a faintly visible virtual object atop the real images to notify a user of the notification event.

18. A method as recited in claim 17, wherein the faintly visible virtual object is transparent.

19. A method for operating a display that permits a view of real images, comprising:
monitoring a user's context; and
alternately presenting information on the display together with the real images when the user is in a first context and not presenting the information on the display when the user is in a second context.

20. A method as recited in claim 19, wherein the information is presented in an at least partially transparent manner.

21. A method as recited in claim 19, wherein the user's context pertains to geographical location and the information comprises at least one mapping object that provides geographical guidance to the user:
the monitoring comprising detecting a direction that the user is facing; and
presenting the mapping object when the user is facing a first direction and not presenting the mapping object when the user is facing in a second direction.

22. A method as recited in claim 2 1, further comprising maintaining the mapping object relative to geographic coordinates so that the mapping object appears to track a particular real image direction relative to a particular real image even though the display is moved relative to the particular real image.

23. A method comprising:
presenting a virtual object on a display together with a view of real world surroundings; and
graphically depicting the virtual object within a border to visually distinguish the virtual object from the view of the real world surroundings.

24. A method as recited in claim 23, wherein the border comprises a geometrical element that encloses the virtual object.

25. A method as recited in claim 23, wherein the border comprises a marquee.

26. A method as recited in claim 23, further comprising:
detecting one or more edges of the virtual object; and
dynamically generating the border along the edges.

27. A method as recited in claim 23, further comprising:
displaying the virtual object with a first degree of transparency; and
displaying the border with a second degree of transparency that is different from the first degree of transparency.

28. A method as recited in claim 23, further comprising:
fading out the virtual object at a first rate;
fading out the border at a second rate so that the border is visible on the display after the virtual object becomes too faint to view.

29. A method comprising:
presenting information on a display that permits a view of real world images; and
modifying color of the information to alternately blend or distinguish the information from the real world images.

30. A method as recited in claim 29, wherein the information is at least partially transparent.

31. A method as recited in claim 29, wherein said modifying is performed in response to change in user context.

32. A method as recited in claim 29, wherein said modifying is performed in response to change in user eye focus on the display.

33. A method as recited in claim 29, wherein said modifying is performed in response to change of importance attributed to the information.

34. A method as recited in claim 29, wherein said modifying is performed in response to a user command.

35. A method as recited in claim 29, further comprising presenting a border around the information.

36. A method as recited in claim 29, further comprising presenting the information as a faintly visible graphic overlaid on the real world images.

37. A method for operating a display that permits a view of real world images, comprising:
presenting information on the display with a first level of prominence; and
modifying the prominence from the first level to a second level.

38. A method as recited in claim 37, wherein said modifying is performed in response to change in user attention between the information and the real world images.

39. A method as recited in claim 37, wherein said modifying is performed in response to change in user context.

40. A method as recited in claim 37, wherein said modifying is performed in response to change of importance attributed to the information.

41. A method as recited in claim 37, wherein said modifying is performed in response to a user command.

42. A method as recited in claim 37, wherein said modifying comprises adjusting transparency of the information.

43. A method as recited in claim 37, wherein said modifying comprises moving the information to another location on the display.

44. A method comprising:
presenting a virtual object on a screen together with a view of a real world environment;
positioning the virtual object in a first location to entice a user to focus on the virtual object;
monitoring the user's focus; and
migrating the virtual object to a second location less noticeable than the first location when the user shifts focus from the virtual object to the real world environment.

45. A method comprising:
presenting at least one virtual object on a view of real world images; and
modifying how the virtual object is presented to alter whether the virtual object is more or less visible relative to the real world images.

46. A method as recited in claim 45, wherein the virtual object is transparent and the modifying comprise changing a degree of transparency.

47. A method as recited in claim 45, wherein the modifying comprises altering a color of the virtual object.

48. A method as recited in claim 45, wherein the modifying comprises changing a location of the virtual object relative to the real world images.

49. A computer comprising:
a display that facilitates a view of real world images;
a processing unit; and
a software module that executes on the processing unit to present a user interface on the display, the user interface presenting information in a transparent manner to allow a user to view the information without impeding the user's view of the real world images.

50. A computer as recited in claim 49, wherein the software module adjusts transparency within a range from fully transparent to fully opaque.

51. A computer as recited in claim 49, further comprising:
context sensors to detect a user's context; and
the software module being configured to adjust transparency of the information presented by the user interface in response to changes in the user's context.

52. A computer as recited in claim 49, further comprising:
a sensor to detect a user's eye focus; and
the software module being configured to adjust transparency of the information presented by the user interface in response to changes in the user's eye focus.

53. A computer as recited in claim 49, wherein the software module is configured to adjust transparency of the information presented by the user interface in response to a user command.

54. A computer as recited in claim 49, wherein the software module moves the information on the display to make the information alternately more or less noticeable.

55. A computer as recited in claim 49, wherein the user interface presents a border around the information.

56. A computer as recited in claim 49, wherein the user interface presents the information within a marquee.

57. A computer as recited in claim 49, wherein the user interface modifies a color of the information presents to alternately blend or distinguish the information from the real world images.

58. A computer as recited in claim 49, embodied as a wearable computer that can be worn by the user.

59. A computer comprising:
a display that facilitates a view of real world images;
a processing unit;
one or more software programs that execute on the processing unit, at least one of the programs generating an event; and
a user interface depicted on the display, where in response to the event, the user interface presents a faintly visible notification overlaid on the real world images to notify the user of the event.

60. A computer as recited in claim 59, wherein the notification is a graphical element.

61. A computer as recited in claim 59, wherein the notification is transparent.

62. A computer as recited in claim 59, embodied as a wearable computer that can be worn by the user.

63. One or more computer-readable media storing computer-executable instructions that, when executed, direct a computer to:
display information overlaid on real world images; and
present the information transparently to reduce obstructing a view of the real world images.

64. One or more computer-readable media as recited in claim 63, further storing computer-executable instructions that, when executed, direct a computer to dynamically adjust transparency of the transparent information.

65. One or more computer-readable media as recited in claim 63, further storing computer-executable instructions that, when executed, direct a computer to display a border around the information.

66. One or more computer-readable media as recited in claim 63, further storing computer-executable instructions that, when executed, direct a computer to modify a color of the information to alternately blend or contrast the information with the real world images.

67. One or more computer-readable media storing computer-executable instructions that, when executed, direct a computer to:
receive a notification event; and
in response to the notification event, display a watermark object atop real world images to notify a user of the notification event.

68. One or more computer-readable media storing computer-executable instructions that, when executed, direct a computer to:
ascertain a user's context;
display information transparently atop a view of real world images; and
adjust transparency of the information in response to a change in the user's context.

69. One or more computer-readable media storing computer-executable instructions that, when executed, direct a computer to:
display information transparently atop a view of real world images;
assign a level of prominence to the information that dictates how prominently the information is displayed to the user; and
adjust the level of prominence assigned to the information.

70. A user interface, comprising:
at least one virtual object overlaid on a view of real world images, the virtual object being transparent; and
a transparency component to dynamically adjust transparency of the virtual object.

71. A user interface as recited in claim 70, wherein the transparency ranges from fully transparent to fully opaque.

72. A system, comprising:
means for presenting at least one virtual object on a view of real world images; and
means for modifying how the virtual object is presented to alter whether the virtual object is more or less visible relative to the real world images.

73. A system as recited in claim 72, wherein the virtual object is transparent and the modifying means alters a degree of transparency.

74. A system as recited in claim 72, wherein the modifying means alters a color of the virtual object.

75. A system as recited in claim 72, wherein the modifying means alters a location of the virtual object relative to the real world images.
